(19) United States
(12) Patent Application Publication
(10) Pub. No.: US 2022/0117829 A1
(43) Pub. Date: Apr. 21, 2022

(54) Walking Frame With Wheels

(71) Applicant: Claudio Rosin, Cormons (IT)

(72) Inventor: Claudio Rosin, Cormons (IT)

(21) Appl. No.: 17/268,639

(22) PCT Filed: Aug. 9, 2019
(86) PCT No.: PCT/IT2019/050184

§ 371 Date: Feb. 16, 2021

(30) Foreign Application Priority Data
Aug. 16, 2018 (IT) 102018000008106

(51) Int. Cl. A61H 3/04

(52) U.S. Cl. CPC A61H 3/04; A61H 2003/046; A61H 2201/0176; A61H 2201/5069; A61H 2201/1481; A61H 2201/1635; A61H 2201/1445

(57) ABSTRACT

Walking frame (10) with wheels (12) comprising a support frame (11) and two gripping elements (13) associated with the support frame (11) that can be gripped by a user.

### FIELD OF THE INVENTION

Embodiments described here concern a walking frame with wheels that can be used as an orthopedic aid to facilitate and assist people with motor disabilities with walking.

### BACKGROUND OF THE INVENTION

Various types of walking frames are known for different types of motor disabilities. Typically, these walking frames are provided with a support frame with a plurality of support points for contact with the ground, and with gripping elements designated as a support and/or grip for the user's hands.

In particular, there are walking frames whose support points are fixed points, which have the disadvantage of needing to be lifted every time the user has to proceed to move forward a few steps. This, as well as being tiring and uncomfortable in the long run, can cause a greater instability for the user since each time the user lifts the walking frame, he/she loses its support and consequently risks falling.

Furthermore, this type of walking frame can only be used for short distances since it requires constant physical effort and mental concentration on the part of the user.

There are also walking frames in which the support points are mobile points, called “rollator” in jargon, that is, provided with wheels in contact with the ground. Four wheels can be provided, or two fixed points and two wheels. Commands can be present on the gripping elements to drive the brakes present on the wheels.

However, this type of walking frame with wheels, although it allows a continuous walking, requires the user to have prompt reflexes since in the event of possible instability he/she has to engage the brakes.

Document WO-A-2008/020049 describes a walking frame with wheels provided with a movement limiting apparatus.

U.S. Pat. No. 4,018,440 describes a walking frame with a wheel control mechanism.

There is therefore the need to perfect a walking frame with wheels that can overcome at least one of the disadvantages of the state of the art.

In particular, one purpose of the present invention is to provide a walking frame that provides greater safety for the user when walking than known walking frames.

Another purpose of the present invention is to provide a walking frame that provides an effective support action even if the user loses his/her balance.

Another purpose of the present invention is to provide a walking frame that does not require significant physical effort by the user to move the walking frame.

It is also a purpose of the present invention to provide a walking frame that can be used as a walking aid even for long distances without requiring excessive physical effort for the user.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

Embodiments concern a walking frame with wheels. In one embodiment, the walking frame comprises:
an assembly to limit the forward travel, configured to limit the rotation of the at least one of the wheels only for a predefined angle of rotation correlated to a predefined limited forward travel of the walking frame, the limiting assembly comprising an anti-rotation device normally active to clamp the rotation of at least one of the wheels of the walking frame in a forward direction of normal advance of the walking frame;
an actuation device configured to deactivate the anti-rotation device so as to selectively enable the rotation of the at least one of the wheels and the forward movement of the walking frame in the direction of normal advance;

wherein the limiting assembly is operatively connected to the actuation device and to the anti-rotation device to be automatically activated following the drive of the actuation device to deactivate the anti-rotation device.

Advantageously, in some embodiments the actuation device can be disposed close to at least one gripping element of the walking frame to facilitate the immediate deactivation of the anti-rotation device for the user.

Advantageously, in some embodiments the actuation device can be selectively driven manually by the user to supply the deactivation command to the anti-rotation device.

Advantageously, in some embodiments the predefined angle of rotation of the wheel can be varied according to the length of the desired distance the user can travel before clamping, in complete safety and stability, the walking frame with the anti-rotation device.

The assembly to limit the travel, in particular thanks to the anti-rotation device, advantageously allows controlled and programmed walking, interspersed with moments of rest. This increases the stability of the user and achieves a greater safety during walking.

Moreover, the presence of the actuation device prevents the user from having to lift the walking frame to move it, as in the case of walking frames with four fixed points. In this way, it is possible for the user to travel longer distances avoiding effort and fatigue with a guaranteed, continuous and stable support action.

Further embodiments concern a method to move forward a walking device with wheels in accordance with the present description. According to one embodiment, the method comprises:
normally keeping at least one of the wheels of the walking frame in a clamped condition, preventing the rotation thereof;
unclamping the rotation of the at least one wheel to allow the walking frame to move forward and to make the walking frame move forward in a direction of normal advance;
while the walking frame is made to move forward in the direction of normal advance, automatically activating a limit to the forward travel of the at least one wheel correlated to a predefined angle of rotation of the wheel;
automatically stopping the walking frame by clamping the at least one wheel when the rotation of the wheel reaches the predefined angle of rotation corresponding to the limit to the forward travel of the at least one wheel.

According to possible embodiments, the walking frame can possibly be used in continuous walking, like the known walking frames, providing an unclamping element or mechanism, activatable by the user, to release the anti-rotation device and the limiting assembly. Consequently, in some embodiments the walking frame can be used in different environments and situations, and can satisfy the needs of different users.

These and other aspects, characteristics and advantages of the present disclosure will be better understood with reference to the following description, drawings and attached claims. The drawings, which are integrated and form part of the present description, show some embodiments of the present invention, and together with the description, are intended to describe the principles of the disclosure.

The various aspects and characteristics described in the present description can be applied individually where possible. These individual aspects, for example aspects and characteristics described in the attached dependent claims, can be the object of divisional applications.

It is understood that any aspect or characteristic that is discovered, during the patenting process, to be already known, shall not be claimed and shall be the object of a disclaimer.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a schematic perspective view of a walking frame in accordance with embodiments described here;

FIGS. 2 to 5 are schematic perspective views of a part of a walking frame in accordance with embodiments described here, in different respective conditions of use;

FIG. 6 is a schematic perspective view of a walking frame in accordance with further embodiments described here;

FIGS. from 7 to 11 schematically represent further embodiments of a walking frame according to the present description;

FIGS. 12 and 13 schematically represent still further embodiments of a walking frame according to the present description.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the various embodiments of the present invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative.

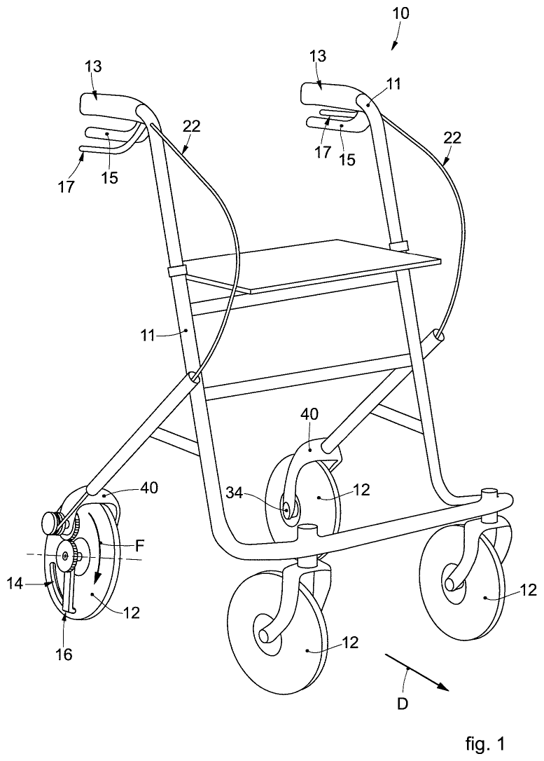

FIGS. 1 to 13 are used to describe embodiments of a walking frame 10 with wheels 12. The walking frame 10 comprises:
an assembly 14 to limit the forward travel, to limit the rotation of the at least one of the wheels 12 only for a predefined angle of rotation α correlated to a predefined limited forward travel of the walking frame 10; the limiting assembly 14 comprises an anti-rotation device 16 normally active to clamp the rotation of at least one of the wheels 12 of the walking frame 10 in a forward direction of normal advance D of the walking frame 10;
an actuation device 17 configured to deactivate the anti-rotation device 16 so as to selectively enable the rotation of the at least one of the wheels 12 and the forward movement of the walking frame 10 in the direction of normal advance D.

The limiting assembly 14 is operatively connected to the actuation device 17 to be automatically activated following the activation of the actuation device 17 to release the anti-rotation device 16. In this way, when the user wishes to move forward with the walking frame 10, he/she deactivates the anti-rotation device 16 by activating the actuation device 17 and, simultaneously with the deactivation and the subsequent forward movement of the walking frame 10, the limiting assembly 14 limits the forward travel and automatically stops the walking frame 10, reactivating the anti-rotation device 16 when the wheels 12 have traveled a segment of forward movement correlated to a rotation corresponding to the predefined angle of rotation α. At this point, the user can once again deactivate the anti-rotation device 16 and the operations described above are repeated for a new limited forward travel and so on.

Further embodiments described using FIGS. 1-13 therefore concern a method to move forward a walking frame 10 with wheels 12 in accordance with the present description. The above method comprises:
normally keeping at least one of the wheels 12 of the walking frame 10 in a clamped condition, preventing the rotation thereof;
unclamping the rotation of the at least one wheel 12 to allow the walking frame 10 to move forward and to make the walking frame 10 move forward in a direction of normal advance D;
while the walking frame 10 is made to move forward in the direction of normal advance D, automatically activating a limit to the forward travel of the at least one wheel 12 correlated to a predefined angle of rotation α of the wheel 12;
automatically stopping the walking frame 10 by clamping the at least one wheel 12 when the rotation of the wheel 12 reaches the predefined angle of rotation α corresponding to the limit to the forward travel of the at least one wheel 12.

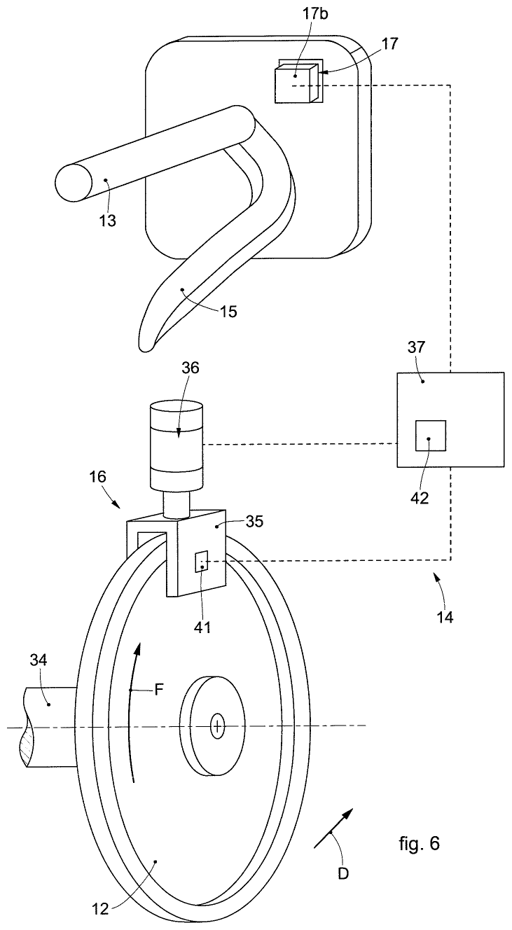

According to some embodiments, the anti-rotation device 16 and the limiting assembly 14 can be of the mechanical type (see for example the embodiments described using FIGS. 1-5 and from 7 to 13) and/or electric type (see for example the embodiments described using FIG. 6).

In accordance with embodiments described using FIGS. from 1 to 5 and from 7 to 13, the limiting assembly 14 comprises:
a first wheel 24, 124 mounted centrally on the at least one wheel 12, which can be integral with a shaft 34 of the at least one wheel 12 and be rotatably connected to the actuation device 17, the first wheel 24, 124 being able to be selectively made to rotate when the actuation device 17 is driven to deactivate the anti-rotation device 16;
a limiting bar 20 that protrudes radially from the first wheel 24, 124, being rotatably integral with the first wheel 24, 124 and provided with a stop tooth 38 protruding axially toward the at least one wheel 12;
an eyelet 33 made on the perimeter of the at least one wheel 12 along a segment of arc having a length correlated to the predefined angle of rotation α and having, at the respective ends, a first 18 and a second 19 end-of-travel abutment.

The first end-of-travel abutment 18 is therefore angularly distanced from the second end-of-travel abutment 19 by an arc corresponding to the predefined angle of rotation α.

According to possible embodiments, the eyelet 33 can have a shape and size suitable to allow the stop tooth 38 to pass from the first end-of-travel abutment 18 to the second end-of-travel abutment 19.

In accordance with embodiments described using FIGS. from 1 to 5 and from 7 to 13, the stop tooth 38 is inserted in the eyelet 33 and is able to slide from the first end-of-travel abutment 18 to the second end-of-travel abutment 19 following the rotation of the first wheel 24, 124 when the actuation device 17 is driven to deactivate the anti-rotation device 16, so as to enable the rotation of the at least one wheel 12 until the first end-of-travel abutment 18 is returned to abut again against the stop tooth 38, for the purpose of moving the walking frame 10 forward for a predefined and limited travel in the direction of normal advance D.

In accordance with embodiments described using FIGS. from 1 to 5 and from 7 to 13, when the limiting bar 20 is in a stop position with the stop tooth 38 abutting against the first end-of-travel abutment 18, the forward rotation of the at least one wheel 12 and therefore the forward movement of the walking frame 10 in the direction of normal advance D is normally prevented.

In general, in possible embodiments, the actuation device 17, as used in association with embodiments described here, can be an actuator of intrinsically circular movement or be configured to convert a linear movement into a circular movement. The conversion can commonly occur by means of types of mechanisms selected from a group which consists of: screw-type actuators, such as a screw jack, ball screw and roller screw actuators, or wheel and axle-type actuators, for example drum, gear, pulley or shaft, actuators, such as a lifting cable, a winch, a rack and pinion unit, a chain drive, a belt drive, rigid chain and rigid belt, or chain, actuators.

In accordance with embodiments described using FIGS. from 1 to 5 and from 7 to 13, the actuation device 17 comprises:
an activation lever 17a selectively mobile along a sliding guide 39, for a drive segment L with a length correlated to the amplitude of the predefined angle of rotation α, between a first stop position 28 in which the anti-rotation device 16 is normally active and a second position 29 of forward movement in which the anti-rotation device 16 is deactivated, and vice versa;
a rotation unit 21 rotatably connected to the first wheel 24, 124 of the limiting assembly 14 to determine the rotation of the first wheel 24, 124;
a motion transmission member 22 connected on one side to the activation lever 17a and on the other side to the rotation unit 21 to determine the rotation of the rotation unit 21 when the activation lever 17a is moved between the first position 28 and the second position 29 along the drive segment L in the sliding guide 39, so that the rotation unit 21 selectively determines the rotation of the first wheel 24, 124 and of the limiting bar 20 radially protruding from it by an angular segment correlated to the amplitude of the predefined angle of rotation α, to take the stop tooth 38 from the first end-of-travel abutment 18 to the second end-of-travel abutment 19.

The rotation unit 21 is therefore connected to the limiting bar 20 and to the actuation device 17 so as to move the limiting bar 20 selectively between the first end-of-travel abutment 18 and the second end-of-travel abutment 19.

In particular, the rotation unit 21 is not rotatable with the wheel 12 with which the limiting assembly 14 is associated.

In accordance with embodiments described using FIGS. from 1 to 5 and from 7 to 13, the rotation unit 21 comprises a second wheel 25, 125 kinematically connected on one side to the transmission member 22 and on the other side to the first wheel 24, 124. The second wheel 25, 125 is able to be made to rotate by driving the transmission member 22 and to transmit in a correlated manner the rotation motion to the first wheel 24, 124.

Therefore, the transmission member 22, due to the action of the actuation device 17 by means of the forward movement of the activation lever 17a along the drive segment L, is configured to make the second wheel 25, 125 and, consequently, the first wheel 24, 124 and the connected limiting bar 20 rotate from the first end-of-travel abutment 18 to the second end-of-travel abutment 19.

In possible implementations, the transmission member 22 comprises a transmission cable 26 attached at a first end to the activation lever 17a of the actuation device 17 and at a second end, opposite the first, to the rotation unit 21.

In further possible embodiments, described using FIGS. 1 to 5, the rotation unit 21 comprises a pulley 27 mounted coaxial to the second wheel 25. The transmission cable 26 is connected, at its second end, to the pulley 27, being able to be at least partly wound around the second pulley 27.

In still further possible implementations, between the pulley 27 and the second wheel 25 a freewheel 31 is mounted interposed, configured to determine the rotation of both the second wheel 25 and also of the pulley 27 in a first direction of rotation, intended to determine the rotation of the first wheel 24 and of the respective limiting bar 20 in order to move the stop tooth 38 from the first end-of-travel abutment 18 to the second end-of-travel abutment 19, when the activation lever 17a, moved from the first position 28 to the second position 29, drives the transmission member 22 and to determine the rotation of the pulley 27 alone and prevent the rotation of the second wheel 25, in a second direction of rotation, opposite the first, when the activation lever 17a is moved from the second position 29 to the first position 28. This possible implementation is advantageous because it increases the safety of the walking frame 10, preventing an undesired reverse rotation of the wheel 12 once the forward travel has been completed and the activation lever 17a is restored to the first position 28, rewinding the cable 26.

In still further possible implementations, the rotation unit 21 comprises a return spring 32 connected to, and in particular mounted on, the pulley 27 and configured to make the pulley 27 automatically rotate in the second direction of rotation when the activation lever 17a is moved from the second position 29 to the first position 28, rewinding part of the cable 26 around the pulley 27.

For example, during the step of unwinding the cable 26 from the pulley 27, that is, when the pulley 27 rotates in a first direction, the return spring 32 loads, that is, it extends without making the freewheel 31 rotate, and the second wheel 25 also rotates in the first direction.

Vice versa, in the step of rewinding the cable 26 on the pulley 27, the return spring 32 comes into action which retracting makes the freewheel 31 and the pulley 27 rotate in a second direction, opposite the first direction, without making the second wheel 25 rotate.

Consequently, the second wheel 25 can rotate only in the first direction and, therefore, the first wheel 24 is constrained to move only in the second direction opposite the first direction.

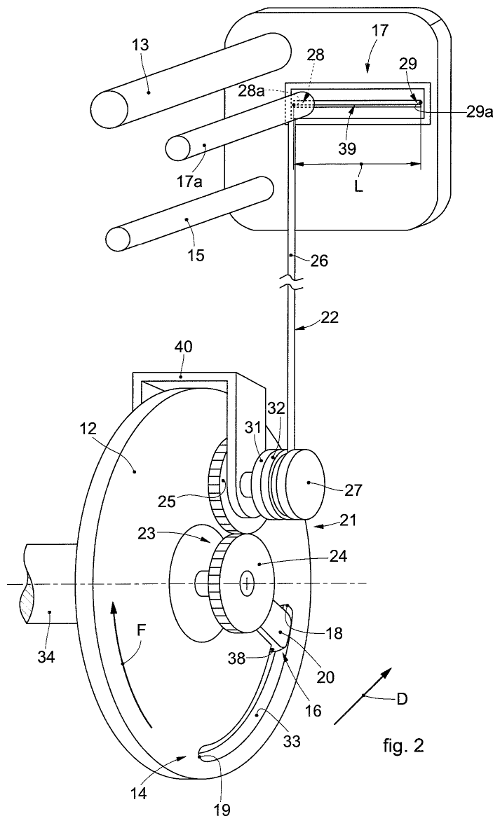

In the example case of FIGS. 2-5, the first direction is counterclockwise while the second direction is clockwise.

According to other possible embodiments not shown, the transmission member 22 can comprise a rod attached with a first end to the activation lever 17a, for example in this case conformed as a knob, and with a second end, opposite the first, to the second wheel 25, 125 of the rotation unit 21. In this case, for example, when the knob is turned in a first direction, the rod moves rigidly and transmits a rotation, in a direction concordant to that of the knob, to the second wheel 25 so as to make the first wheel and the connected limiting bar 20 rotate in a second direction, opposite the first direction.

In accordance with embodiments described using FIGS. from 1 to 13, the walking frame 10 comprises a support frame 11. In some embodiments, the rotation unit 21 is integrally connected to the support frame 11.

In accordance with embodiments described using FIGS. from 1 to 5 and from 7 to 13, the actuation device 17 comprises the sliding guide 39 made in the support frame 11, at the ends of which abutment surfaces 28a, 29a are provided to define the drive segment L of the activation lever 17a between the first position 28 and the second position 29. The activation lever 17a is inserted with one of its ends inside the sliding guide 39 to slide along the drive segment L in the sliding guide 39. The actuation device 17 also comprises an elastic return element 30 disposed in the sliding guide 39 and attached on one side to an abutment surface 28a of the sliding guide 39 in correspondence with the first position 28 and on the other side to the activation lever 17a, in order to recall the activation lever 17a automatically from the second position 29, where it is in abutment against the abutment surface 29a, to said first position 28, where it abuts against the abutment surface 28a.

According to a possible embodiment, the sliding guide 39 can have any shape and size suitable for the sliding of the activation lever 17a from the first position 28 to the second position 29 and vice versa. For example, the sliding guide 39 can be linear, or follow a path that is at least partly curved. According to a possible embodiment, the sliding guide 39 can be, for example, horizontal, vertical, oblique or curved or other still suitable shapes.

In accordance with further embodiments described using FIGS. from 1 to 13, the walking frame 10 comprises at least one gripping element 13 that can be gripped by a user.

In the embodiments described using FIGS. from 1 to 5 and from 7 to 13, the activation lever 17a is disposed in correspondence with the gripping element 13, in particular on the side of the gripping element 13 with respect to the direction of normal advance D. In some advantageous embodiments, the actuation device 17 can be driven by moving the activation lever 17a away from one of the gripping elements 13 toward the outside.

In embodiments described using FIGS. 1-5, the first wheel 24 of the limiting assembly 14 and the second wheel 25 of the rotation unit 21 can for example be toothed wheels configured to engage with each other by means of respective toothed gears 23.

In embodiments described using FIGS. 1-5 and from 7 to 13, the second wheel 25, 125 can be connected to the shaft 34 of the respective wheel 12 by means of an attachment bracket 40.

The attachment bracket 40 advantageously maintains the second wheel 25, 125 raised with respect to the external circular surface of the wheel 12 so that the eyelet 33 of the wheel 12, including the first end-of-travel abutment 18 and the second end-of-travel abutment 19, and the limiting bar 20 can complete a revolution of 360°, following the rotation of the wheel 12, without encountering obstacles.

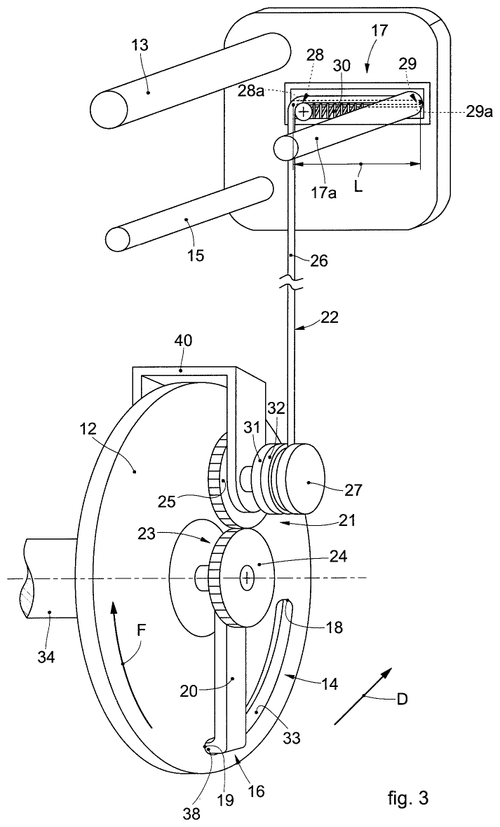

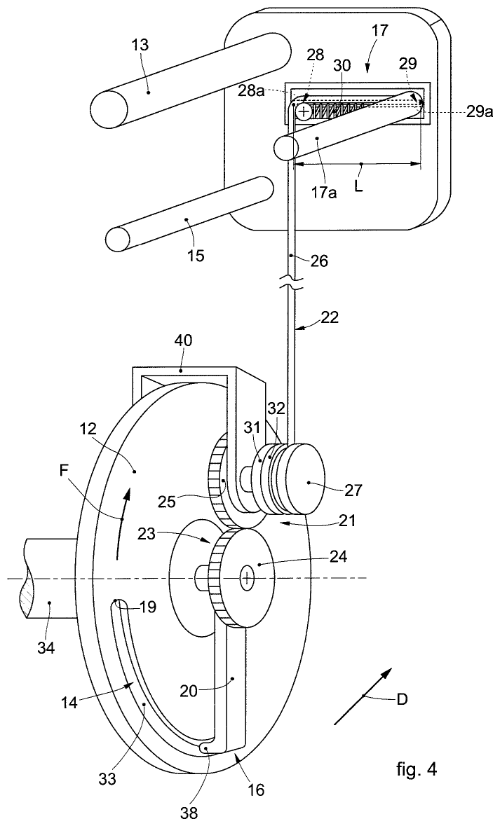

In accordance with the embodiments described using FIGS. from 1 to 5 and from 7 to 13, when the limiting bar 20 is positioned so that the stop tooth 38 abuts against the first end-of-travel abutment 18, the anti-rotation device 16 is active and the walking frame 10 cannot move forward in the direction of normal advance D, since the rotation, indicated with an arrow F, of the at least one of the wheels 12, on which the anti-rotation device 16 is mounted, is prevented (FIGS. 1 and 7). On the other hand, when the anti-rotation device 16 is deactivated, the limiting bar 20 is positioned so that the stop tooth 38 abuts against the second end-of-travel abutment 19 (FIGS. 3 and 11), after which the walking frame 10 can be moved in the direction of normal advance D until the limiting bar 20 is again positioned with the stop tooth 38 in abutment against the first end-of-travel abutment 18 (for example FIG. 4).

Consequently, the movement of the walking frame 10 can be advantageously limited to a predefined travel for the user, guaranteeing safety, a greater control and an increased stability in the user's walking.

FIGS. 2-5 show in detail a method to use the walking frame 10 in accordance with possible embodiments.

FIG. 2 shows by way of example and schematically the walking frame 10 with the anti-rotation device 16 normally active, that is, when the activation lever 17a of the actuation device 17 is in the first position 28 and the elastic return element 30, associated with the activation lever 17a, is in the initial inactive position. In this configuration, if an attempt is made to move forward with the walking frame 10 in the direction of normal advance D, the limiting bar 20 is with the stop tooth 38 in abutment against the first end-of-travel abutment 18 and this does not allow the rotation of the wheel 12, illustrated with an arrow F.

FIG. 3 shows by way of example and schematically the walking frame 10 with the actuation device 17 driven, that is, when the activation lever 17a is thrust along the sliding guide 39 for the drive segment L, into the second position 29, extending the elastic return element 30. In this configuration, the cable 26 follows the movement of the activation lever 17a and, unwinding from the pulley 27, makes the second wheel 25 rotate in a first direction, in this case clockwise, and consequently makes the first wheel 24 rotate in a second direction, in this case counter-clockwise, opposite the first direction.

The stop tooth 38 of the limiting bar 20 slides along the eyelet 33 of the wheel 12 from the first end-of-travel abutment 18 to the second end-of-travel abutment 19 allowing the rotation of the wheel 12 according to the arrow F and the consequent forward movement of the walking frame 10 in the direction of normal advance D.

FIG. 4 shows by way of example and schematically the walking frame 10 with the activation lever 17a of the actuation device 17 still active in the second position 29 and after the walking frame 10 has traveled a distance equal to the rotation of the wheel 12 of the predefined angle of rotation α. After walking, the limiting bar 20 has passed from the second end-of-travel abutment 19 to the first end-of-travel abutment 18. In this configuration, the rotation of the wheel 12, indicated with the arrow F, and the consequent forward movement of the walking frame 10 in the direction of normal advance D, are prevented.

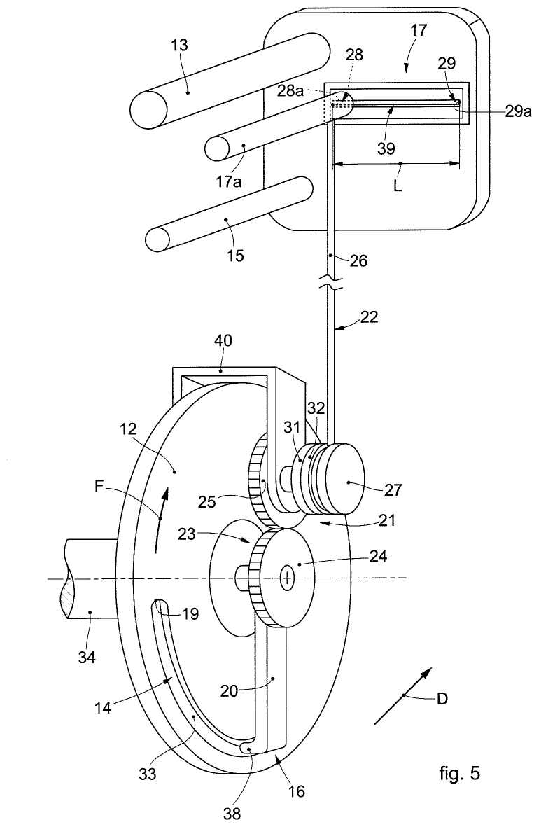

FIG. 5 shows by way of example and schematically the walking frame 10 with the anti-rotation device 16 activated again, that is, when the activation lever 17a returns in the first position 28 following the resetting of the elastic return element 30 into its normal initial inactive position. The cable 26 is rewound onto the pulley 27 by means of the freewheel 31 and the return spring 32 associated with the pulley 27 itself. As described above, the presence of the freewheel 31 and of the return spring 32 leads to rewind the transmission member 22, in this case the cable 26, onto the pulley 27 without making the second wheel 25 rotate. In this way, the limiting bar 20 remains in abutment on the first end-of-travel abutment 18 preventing the forward movement of the walking frame 10 in the direction of normal advance D.

According to one embodiment, the walking frame 10 can also be provided with an unclamping mechanism able to release the anti-rotation device 16 and the limiting assembly 14 to allow the normal and continuous functioning of the walking frame 10.

According to a possible embodiment, the unclamping mechanism can comprise, for example, a pedal connected to the shaft 34 of one of the wheels 12 and a retractable element. When the pedal is pressed, the retractable element is triggered and moves the first wheel 24 externally so that the stop tooth 38 of the limiting bar 20 disengages, exiting, from the eyelet 33, so as not to interfere with the normal forward movement of the walking frame 10. When the pedal is pressed again, the retractable element is retracted so that the first wheel 24 again engages the second wheel 25 and the stop tooth 38 of the limiting bar 20 again engages retracting into the eyelet 33.

Advantageously, in the embodiments described using the attached drawings, therefore, the user can repeatedly drive the actuation device 17 so as to be able to travel preset distances, interspersed with moments of rest, in complete safety.

In fact, the walking frame 10 in accordance with the embodiments described here does not require significant physical effort on the part of the user to move the walking frame 10 itself, since it is sufficient to drive the actuation device 17 to allow the movement of the walking frame 10 without having to lift it. Consequently, the walking frame 10 according to the embodiments described here can also be used for relatively long distances without the user tiring excessively.

In accordance with some embodiments, combinable with all the embodiments described here, the walking frame 10 comprises a brake 35 associated with one of the wheels 12, drivable by means of a respective braking lever 15.

According to one possible embodiment, the braking lever 15 can possibly be associated with the gripping elements 13 so that, when the anti-rotation device 16 and the limiting assembly 14 are released, the user, in case of instability, can use the braking lever 15.

In possible implementations, the brake 35 can be an autonomous and separate component from the anti-rotation device 16 and the limiting assembly 14.

In other possible implementations, the brake 35 can be a component comprised at least partly in the anti-rotation device 16 and/or in the limiting assembly 14.

In accordance with embodiments described using FIG. 6, the anti-rotation device 16 comprises a brake 35 mounted on the at least one wheel 12. The brake 35 is normally in a clamped condition to prevent the rotation of the at least one wheel 12. In these embodiments, the actuation device 17 comprises an activation button 17b to deactivate the brake 35. Furthermore, in these embodiments, the limiting assembly 14 comprises a control and command unit 37 of the electronic type (also called electronic system controller), provided with a memory 42. Advantageously, the desired angle of rotation α or a datum or value correlated thereto is or can be preset and possibly adjusted in the memory 42. According to a possible embodiment, the angle of rotation α, that is, the angle of maximum rotation allowed for the wheel 12 after receiving the deactivation command of the anti-rotation device 16, can be preset by the user in the memory 42 of the control and command unit 37.

Moreover, the limiting assembly 14, in these embodiments, comprises an angular sensor 41 configured to detect an amplitude of the angle of rotation of said at least one wheel 12, that is, its angular displacement, when the walking frame 10 is made to move forward in the direction of normal advance D, and supply a respective signal to the control and command unit 37. For example, the angular sensor 41 can be a rotational encoder, an optical or optoelectronic sensor or a combination thereof.

The control and command unit 37 is connected both to the activation button 17b, and also to the brake 35.

Moreover, the control and command unit 37 is configured to receive and process the command signal received from the activation button 17b to deactivate the brake 35, transmitting a corresponding signal to the brake 35 for its deactivation, unclamping the rotation of the at least one wheel 12 and allowing its rotation for the purposes of moving the walking frame 10 forward along the direction of normal advance D.

Moreover, in these embodiments the control and command unit 37 is configured to process the signal received from the angular sensor 41 when the at least one wheel 12, with the brake 35 deactivated, is made to rotate to move the walking frame 10 forward, comparing the processed signal with a predefined rotation value correlated to the angle of rotation α and set in the memory 42, and then provide a command signal to drive the brake 35 into the clamped condition, when the rotation of the wheel 12 detected by the angular sensor 41 corresponds to the predefined rotation value correlated to the predefined angle of rotation α and set in the memory 42, so as to stop the walking frame 10 when the predefined limited forward travel has been completed.

In possible implementations, the limiting assembly 14 also comprises an electric actuator 36 connected to the brake 35 and to the control and command unit 37 to activate/deactivate the brake 35 according to a corresponding signal received from the control and command unit 37.

In these embodiments described using FIG. 6, while the walking frame 10 is made to move forward in the direction of normal advance D, the automatic activation of the limitation of the forward travel of the at least one wheel 12 correlated to a predefined angle of rotation α provides to automatically detect an amplitude of the angle of rotation of the at least one wheel 12 comparing the amplitude of the angle of rotation with a predefined angle of rotation α correlated to a predefined limited forward travel of the walking frame 10. Furthermore, in these embodiments, the walking frame 10 stops automatically clamping the at least one wheel 12 when it has been detected that the rotation of the wheel 12 corresponds to the predefined angle of rotation α so as to limit the forward movement of the walking frame 10 to a predefined limited forward travel correlated to the predefined angle of rotation α.

In the embodiments described using FIG. 6, when the user drives the actuation device 17, the control and command unit 37 deactivates the brake 35, and when the walking frame 10 is made to move forward and the wheels 12 rotate, the control and command unit 37 compares the angular displacement detected and sent to it by the angular sensor 41 with the angle of rotation α preset in the memory 42. If the angle of rotation α is substantially equal to the angular displacement detected, the control and command unit 37 commands the electric actuator 36 to brake the wheel 12. In this case, the angle of rotation α can vary from a few degrees to multiples of 360° according to the maximum distance to be covered before the walking frame 10 is clamped by the anti-rotation device 16.

The control and command unit 37 can be connected by means electrical connections via cable, or in wireless mode, to the angular sensor 41, to the actuation device 17 and to the electric actuator 36.

In the embodiments described using FIG. 6, the walking frame 10 can also provide a button to unclamp and deactivate the anti-rotation device 16 and the limiting assembly 14, positioned for example near the actuation device 17. The unclamping button can be connected to the control and command unit 37.

According to possible embodiments, the brake 35 could be a braking device connected to the braking lever 15 and present on at least one wheel 12. In this case, the unclamping button can deactivate the normal activation of the anti-rotation device 16 and switch off or in any case deactivate the control and command unit 37 so that the brake 35 can be driven directly by the braking lever 15.

In some embodiments, combinable with all the embodiments described here, the angle of rotation α can be selected during the design step so as to be a fraction of a round angle (360°), for example from a few degrees to a maximum of 340° or 350°, in particular in the case of the embodiments described using FIGS. 1-5 and from 7 to 13, or even multiples or sub-multiples of a round angle, or other combinations, in particular in the case of the embodiments described using FIG. 6, depending on the maximum travel that is to be completed before the walking frame 10 is again clamped by the anti-rotation device 16.

In accordance with some embodiments, combinable with all the embodiments described here, the activation lever 17a or the activation button 17b of the actuation device 17 can be selectively driven manually by the user to supply the deactivation command to the anti-rotation device 16.

According to some embodiments, combinable with all the embodiments described here, the limiting assembly 14, and in particular the anti-rotation device 16, can be applied on at least two opposite wheels 12 of the walking frame 10.

With reference to the embodiments described using FIG. 1, combinable also with the embodiments described using FIG. 6, the walking frame 10 with wheels 12 comprises the support frame 11 and two gripping elements 13 associated with the support frame 11 which can be gripped by a user.

According to one embodiment, the actuation device 17 can be associated with at least one of the gripping elements 13.

In possible implementations, the support frame 11 can have different shapes and can be made of different materials, for example metal and/or plastic, taking care it is sized to support adequate weight loads. Moreover, the support frame 11 can have different housings suitable for the insertion of various accessories, for example a shelf or a basket to transport personal objects or purchases of the user.

Typically, the shape of the support frame 11 is such as to guarantee structural solidity to the walking frame 10 itself and stability and comfort in the support and walking of the user.

Moreover, the support frame 11 comprises in this case four wheels 12 which rotate around a respective shaft 34 connected to the support frame 11, in particular integral therewith.

FIGS. 7 to 13 are used to describe further embodiments, combinable with the embodiments described using FIGS. 1 to 5, in which a Maltese cross mechanism, also known as Geneva drive, is used to make the limiting assembly 14 and the rotation unit 21.

In these embodiments, the first wheel, indicated with reference number 124, of the limiting assembly 14 and the second wheel, indicated with reference number 125, of the rotation unit 21 are configured as a Maltese cross mechanism.

In these embodiments, the first wheel is in particular a first cross-shaped wheel 124, having radial lobes disposed as a cross each provided with a slit 123 oriented radially. The four slits 123 on the first wheel 124 are symmetrical and generally with a linear axis directed radially and open toward the outside. The first wheel 124 is a driven wheel, that is, it is driven by the second wheel 125. The limiting bar 20 described above is disposed on the first wheel 124.

The second wheel 125 of the rotation unit 21 is a drive wheel, driven in rotation, for example in the direction indicated by the arrow G (first direction) by means of the transmission member 22, in particular the cable 26, in turn driven by means of the actuation device 17. In particular, the rotation of the second wheel 125 as indicated by the first direction of the arrow G is of 360° when the actuation device 17 is driven for the entire length of the drive segment L along the sliding guide 39.

In the embodiments described using FIGS. 7 to 11, the second wheel 125 carries a pawl 225 which, in use when the second wheel 125 turns, slots into one of the slits 123. The pawl 225 slots into the respective slit 123 with an alternate in-and-out motion from the outside to the inside and again to the outside of the mechanism. The pawl 225, slotting into the slit 123, makes the first wheel 124 rotate by a certain angular amplitude, advantageously correlated to the length of the eyelet 33 and therefore of the free distance that can be covered with the walking frame 10.

As described above, the first wheel 124 has four slits 123 and to each 360° rotation of the second wheel 125 corresponds a 90° rotation of the first wheel 124.

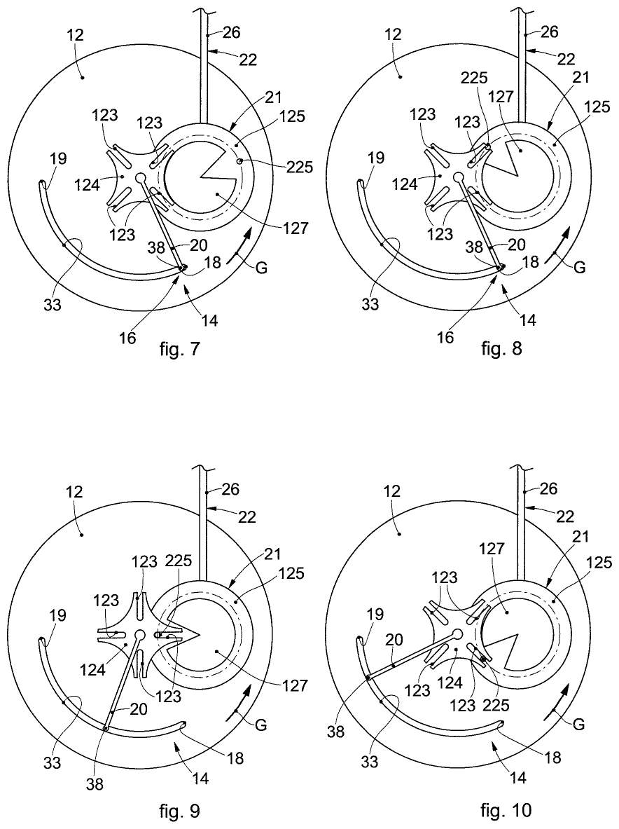

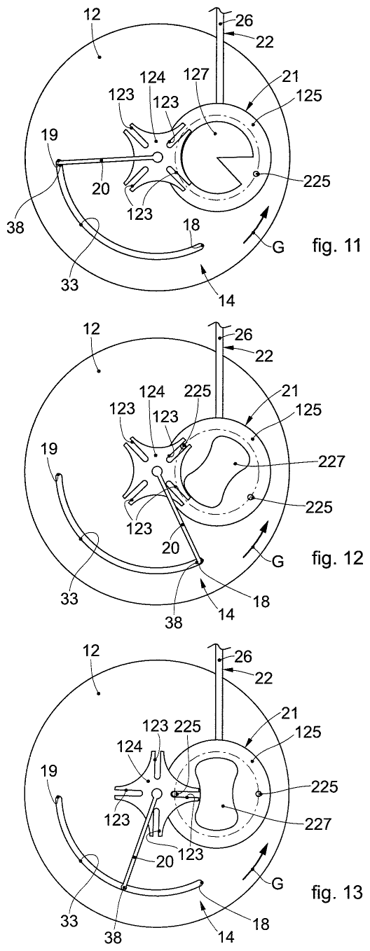

In the embodiments described using FIGS. 12 and 13, the second wheel 125 carries two pawls 225 disposed diametrically opposite, whose function is always to slot into respective slits 123 to make the first wheel 124 move forward in rotation. Advantageously, in this way, a 180° rotation of the first wheel 124 corresponds to each 360° rotation of the second wheel 125. These embodiments, therefore, are advantageous if one wishes to increase the angle that is covered by the limiting bar 20, therefore the length of the eyelet 33 and consequently the free distance that can be covered with the walking frame 10.

In the embodiments described using FIGS. 7 to 13, the second wheel 125 advantageously consists of a solid body to stabilize the rotation and is integral with a central body in relief 127, 227 shaped with at least one curved part to go into sliding friction with the first wheel 124 in order to keep it in position. For example, in the embodiments described using FIGS. 7 to 11 the central body in relief 127 is essentially a disk without an angular sector to position the pawl 225, while in the embodiments described using FIGS. 12 and 13 the central body in relief 227 is essentially a bilobed body, with two opposite curved portions and two concavities to position the two pawls 225.

In some embodiments, a variant of the Maltese cross mechanism is also provided, that is, a so-called “internal” variant in which externally there is a driven wheel with internal radial slits, that is, which open toward the center, while internally there is a drive wheel with a pawl that, at each turn of the drive wheel, slots into one of the slits, with an alternating in-and-out motion from the inside to the outside and again to the inside of the mechanism.

The general functioning of the walking frame 10 in the case of the embodiments described using FIGS. 7 to 13 is the same as the one described for the embodiments of FIGS. 1 to 5 and will be briefly described below.

It should be noted that the walking frame 10, initially before its use, could not be clamped since the limiting bar 20 could be in any position whatsoever along the eyelet 33. However, after making the walking frame 10 move forward, the limiting bar 20 is inevitably displaced and is in the position shown in FIG. 7. For that matter, this also applies to the embodiments described using FIGS. 1 to 5, where initially the limiting bar 20 could be in any position whatsoever, but at the first forward movement of the walking frame 10, the limiting bar 20 is displaced and is in the position shown FIG. 2.

Continuing the description with reference to FIGS. 7 to 13, in particular FIG. 7 represents the case in which the walking frame 10 is stationary and the forward movement is blocked by the fact that the limiting bar 20 is with the stop tooth 38 against the first end-of-travel abutment 18 of the eyelet 33, without having yet driven the actuation device 17.

FIG. 8 shows the case in which the actuation device 17 is driven and the transmission member 22 makes the second wheel 125 rotate, causing the pawl 225 to be inserted in the respective slit 123 of the first wheel 124. In this case, the walking frame 10 is still clamped because the limiting bar 20 is still with the stop tooth 38 against the first end-of-travel abutment 18 of the eyelet 33.

FIGS. 9 and 10 show the case in which, continuing the activation of the actuation device 17, the second wheel 125 continues to rotate, also making the limiting bar 20 rotate, which moves along the eyelet 33 toward the second end-of-travel abutment 19. In FIG. 10 it can be seen that the pawl 225 is about to exit from the slit 123 as the limiting bar 20 approaches the second end-of-travel abutment 19.

FIG. 11 shows the case in which the pawl 225 has completely exited from the slit 123 and the second wheel 125 has performed a rotation of 360° and the limiting bar 20 has reached the second end-of-travel abutment 19, allowing the respective wheel 12 to move forward by the distance allowed and therefore correlated to the length of the eyelet 33.

It is clear that modifications and/or additions of parts may be made to the walking frame 10 and the corresponding method of use as described heretofore, without departing from the field and scope of the present invention.

It is also clear that, although the present invention has been described with reference to some specific examples, a person of skill in the art shall certainly be able to achieve many other equivalent forms of walking frame 10 and corresponding method, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. Walking frame with wheels (12), characterized in that said walking frame (10) comprises:
an assembly (14) to limit the forward travel, configured to limit the rotation of said at least one of the wheels (12) only for a predefined angle of rotation (α) correlated to a predefined limited forward travel of said walking frame (10), said limiting assembly (14) comprising an anti-rotation device (16) normally active to clamp the rotation of at least one of the wheels (12) of the walking frame (10) in a forward direction of normal advance (D) of said walking frame (10);
an actuation device (17) configured to deactivate said anti-rotation device (16) so as to selectively enable the rotation of said at least one of the wheels (12) and the forward movement of said walking frame (10) in the direction of normal advance (D);
said limiting assembly (14) being operatively connected to said actuation device (17) to be automatically activated following the drive of the actuation device (17) to deactivate said anti-rotation device (16);
wherein said limiting assembly (14) also comprises:
a first wheel (24, 124) mounted centrally on said at least one wheel (12), and able to be selectively made to rotate when said actuation device (17) is driven to deactivate said anti-rotation device (16);
an eyelet (33) made on the perimeter of said at least one wheel (12) along a segment of arc having a length correlated to said predefined angle of rotation (α) and having, at the respective ends, a first (18) and a second (19) end-of-travel abutment;
wherein said anti-rotation device (16) of said limiting assembly (14) comprises a limiting bar (20) that protrudes radially from said first wheel (24, 124), being rotatably integral with said first wheel (24, 124) and provided with a stop tooth (38) protruding axially toward said at least one wheel (12), said stop tooth (38) being inserted into said eyelet (33) and being able to slide from said first end-of-travel abutment (18) to said second end-of-travel abutment (19) following the rotation of said first wheel (24, 124) when said actuation device (17) is driven to deactivate said anti-rotation device (16), so as to enable the rotation of said at least one wheel (12) until said first end-of-travel abutment (18) is returned to abut again against said stop tooth (38), for the purpose of moving said walking frame (10) forward for a predefined and limited travel in said direction of normal advance (D).
wherein said actuation device (17) comprises:
an activation lever (17a) selectively mobile along a sliding guide (39), between a first stop position (28) in which said anti-rotation device (16) is normally active and a second position (29) of forward movement in which said anti-rotation device (16) is deactivated, and vice versa;
a rotation unit (21) rotatably connected to said first wheel (24, 124) of said limiting assembly (14) to determine the rotation of said first wheel (24, 124);
a motion transmission member (22) connected on one side to said activation lever (17a) and on the other side to said rotation unit (21) to determine the rotation of said rotation unit (21) when said activation lever (17a) is moved between said first position (28) and said second position (29) along said sliding guide (39), so that said rotation unit (21) selectively determines the rotation of said first wheel (24, 124) and of the limiting bar (20) radially protruding from it, to take said stop tooth (38) from said first end-of-travel abutment (18) to said second end-of-travel abutment (19).

2. Walking frame as in claim 1, characterized in that when said limiting bar (20) is in a stop position with said stop tooth (38) abutting against said first end-of-travel abutment (18), the forward rotation of said at least one wheel (12) and therefore the forward movement of said walking frame (10) in said direction of normal advance (D) is normally prevented.

3. Walking frame as in claim 1, characterized in that at the ends of said sliding guide (39) abutment surfaces (28a, 29a) are provided, to define the length of a drive segment (L) of said activation lever (17a) between said first position (28) and said second position (29) along said sliding guide (39), said activation lever (17a) being inserted with one of its ends in said sliding guide (39) to slide along said sliding guide (39), said actuation device (17) also comprising an elastic return element (30) disposed in said sliding guide (39) and attached on one side to an abutment surface (28a) of said sliding guide (39) in correspondence with said first position (28) and on the other side to said activation lever (17a), in order to recall said activation lever (17a) automatically from said second position (29) to said first position (28).

4. Walking frame as in claim 1, characterized in that said rotation unit (21) comprises a second wheel (25, 125) kinematically connected on one side to said transmission member (22) and on the other side to said first wheel (24, 124), said second wheel (25, 125) being able to be made to rotate by driving the transmission member (22) and to transmit in a correlated manner the rotation motion to said first wheel (24, 124).

5. Walking frame as in claim 1, characterized in that the transmission member (22) comprises a transmission cable (26) attached at a first end to the activation lever (17a) of the actuation device (17) and at a second end, opposite the first, to the rotation unit (21).

6. Walking frame as in claim 4, characterized in that said rotation unit (21) comprises a pulley (27) mounted coaxial to said second wheel (25), said transmission cable (26) being connected, at its second end, to said pulley (27), being able to be at least partly wound around said second pulley (27).

7. Walking frame as in claim 6, characterized in that between the pulley (27) and the second wheel (25) a freewheel (31) is mounted interposed, configured to determine the rotation of both the second wheel (25) and also of the pulley (27) in a first direction of rotation, intended to determine the rotation of the first wheel (24) and of the respective limiting bar (20) in order to move the stop tooth (38) from the first end-of-travel abutment (18) to the second end-of-travel abutment (19), when the activation lever (17a), moved from the first position (28) to the second position (29), drives the transmission member (22) and to determine the rotation of the pulley (27) alone and prevent the rotation of the second wheel (25), in a second direction of rotation, opposite the first, when the activation lever (17a) is moved from the second position (29) to the first position (28).

8. Walking frame as in claim 7, characterized in that the rotation unit (21) comprises a return spring (32) connected to said pulley (27) and configured to make the pulley (27) automatically rotate in the second direction of rotation when the activation lever (17a) is moved from the second position (29) to the first position (28), rewinding part of said cable (26) around said pulley (27).

9. Walking frame as in claim 4, characterized in that the first wheel (124) of the limiting assembly (14) and the second wheel (125) of the rotation unit (21) are configured as a Maltese cross mechanism.

10. Walking frame as in claim 1, characterized in that said walking frame (10) comprises a support frame (11) and said sliding guide (39) is made in said support frame (11).

11. Walking frame as in claim 1, characterized in that said walking frame (10) comprises at least one gripping element (13) which can be gripped by a user, said activation lever (17a) being disposed in correspondence with said gripping element (13), in particular on the side of said gripping element (13) with respect to said direction of normal advance (D).

12. Walking frame as in claim 1, characterized in that it comprises a brake (35) associated with one of the wheels (12), which can be driven by means of a respective braking lever (15).

13. Method to move forward a walking frame (10) with wheels (12) as in claim 1, characterized in that said method comprises:
normally keeping at least one of the wheels (12) of the walking frame (10) in a clamped condition, preventing the rotation thereof;
unclamping the rotation of said at least one wheel (12) to allow the walking frame (10) to move forward and to make said walking frame (10) move forward in a direction of normal advance (D);
while said walking frame (10) is made to move forward in said direction of normal advance (D), automatically activating a limit to the forward travel of said at least one wheel (12) correlated to a predefined angle of rotation (α) of said wheel (12);
automatically stopping said walking frame (10) by clamping said at least one wheel (12) when the rotation of the wheel (12) reaches said predefined angle of rotation (α) corresponding to said limit to the forward travel of said at least one wheel (12).
